(19) United States
(12) Patent Application Publication
(10) Pub. No.: US 2025/0088779 A1
(43) Pub. Date: Mar. 13, 2025

(54) LOUDSPEAKERS

(71) Applicant: SHENZHEN SHOKZ CO., LTD., Shenzhen (CN)

(72) Inventors: Wenbing ZHOU, Shenzhen (CN); Lei ZHANG, Shenzhen (CN); Xin QI, Shenzhen (CN); Fengyun LIAO, Shenzhen (CN); Shanyong GU, Beijing (CN)

(73) Assignee: SHENZHEN SHOKZ CO., LTD., Shenzhen (CN)

(21) Appl. No.: 18/959,542

(22) Filed: Nov. 25, 2024

Related U.S. Application Data
(63) Continuation of application No. PCT/CN2022/127235, filed on Oct. 25, 2022.

(51) Int. Cl. H04R 1/02

(52) U.S. Cl. CPC H04R 1/02

(57) ABSTRACT

A loudspeaker comprising a diaphragm, a housing, and a cavity structure is provided. The diaphragm is configured to vibrate to produce air-conducted sound waves. The housing is configured to form an accommodation cavity for housing the diaphragm. The diaphragm divides the accommodation cavity into a front cavity and a rear cavity. The housing is provided with a sound outlet hole communicating with the front cavity, and at least a portion of the air-conducted sound waves is transmitted through the sound outlet hole to an exterior of the loudspeaker. The cavity structure is provided on the housing and communicated with at least one of the front cavity and the rear cavity, and the cavity structure is configured to absorb a sound wave with a target frequency in the air-conducted sound waves.

### CROSS-REFERENCE TO RELATED APPLICATIONS

This application is a Continuation of International Application No. PCT/CN2022/127235, filed on Oct. 25, 2022, the entire contents of which are incorporated herein by reference.

### TECHNICAL FIELD

The present disclosure relates to the field of acoustic devices, and in particular to a loudspeaker provided with a cavity structure on a housing.

### BACKGROUND

With the continuous development of electronic devices, acoustic output devices (e.g., earphones) have become an indispensable social and entertainment tool in people's daily lives, and people's requirements for acoustic output devices are getting higher and higher. However, existing acoustic output devices still suffer from many problems, such as complex structure and poor sound quality. Therefore, it is expected to provide an acoustic output device with a simple structure and high acoustic performance to meet the needs of users.

### SUMMARY

One of the embodiments of the present disclosure provides a high-performance loudspeaker comprising a diaphragm configured to vibrate to produce air-conducted sound waves and a housing configured to form an accommodation cavity for housing the diaphragm. The diaphragm divides the accommodation cavity into a front cavity and a rear cavity, the housing is provided with a sound outlet hole communicating with the front cavity, and at least a portion of the air-conducted sound waves is transmitted through the sound outlet hole to an exterior of the loudspeaker. A cavity structure is provided on the housing and communicated with at least one of the front cavity and the rear cavity, and the cavity structure is configured to absorb a sound wave with a target frequency in the air-conducted sound waves.

In some embodiments, vibration of the diaphragm has a primary resonant frequency, a difference between the primary resonant frequency and the target frequency being within 300 Hz.

In some embodiments, the target frequency is in a range of 3 kHz-20 kHz.

In some embodiments, the front cavity is communicated with the sound outlet hole through a sound guiding channel, and the cavity structure is communicated with the sound guiding channel through the front cavity.

In some embodiments, the housing includes a front cavity plate, a rear cavity plate, and a side plate, and the cavity structure includes a connecting hole and an acoustic absorbing cavity.

In some embodiments, the connecting hole is communicated with the acoustic absorbing cavity through a sound guiding tube.

In some embodiments, an equivalent diameter of the sound guiding tube is not less than 0.05 mm.

In some embodiments, an equivalent diameter of the connecting hole is not less than 0.1 mm.

In some embodiments, a parameter e takes a value in a range of 1000 (1/m²)-40000 (1/m²), wherein:

$$θ = \frac{S}{l * V}$$

where S denotes a transverse area of the connecting hole, l denotes a length of the connecting hole, and V denotes a volume of the acoustic absorbing cavity.

In some embodiments, the cavity structure is disposed in the rear cavity plate, the rear cavity plate includes a front cavity wall, a side cavity wall, and a back plate that form the cavity structure.

In some embodiments, the back plate is a damping mesh.

In some embodiments, an acoustic absorbing material is provided on the back plate.

In some embodiments, the front cavity wall is the damping mesh.

In some embodiments, the connecting hole is disposed within a projection of the diaphragm along a vibrational direction of the diaphragm.

In some embodiments, the diaphragm includes a folded-ring portion and a fixed end, and the connecting hole is arranged directly opposite to the folded-ring portion of the diaphragm.

In some embodiments, the speaker further comprises a driving unit configured to generate vibration based on an electrical signal and drive the diaphragm to vibrate.

In some embodiments, driving unit is provided in the rear cavity, the driving unit cooperates with the rear cavity plate to divide the rear cavity into a first rear cavity and a second rear cavity, and the second rear cavity is composed of the driving unit and the rear cavity plate.

In some embodiments, the cavity structure is in communication with the first rear cavity but not in communication with the second rear cavity.

In some embodiments, the cavity structure is in communication with the first rear cavity and the second rear cavity.

In some embodiments, the cavity structure includes at least two cavity structures, wherein a portion of the at least two cavity structures is in communication with the first rear cavity but not in communication with the second rear cavity, and the other portion of the at least two cavity structures is in communication with the first rear cavity and the second rear cavity.

In some embodiments, the cavity structure is provided in the front cavity plate.

In some embodiments, the cavity structure includes at least two cavity structures arranged symmetrically with respect to a central axis of the loudspeaker.

In some embodiments, the at least two cavity structures are configured to absorb sound waves with a same frequency or different frequencies in the air-conducted sound waves.

### BRIEF DESCRIPTION OF THE DRAWINGS

The present disclosure will be further illustrated by way of exemplary embodiments, which will be described in detail through the accompanying drawings.

These embodiments are not limiting, and in these embodiments, the same numbering denotes the same structure, wherein:

FIG. 1 is a block diagram of an exemplary loudspeaker according to some embodiments of the present disclosure;

FIG. 2A is a schematic diagram of an exemplary mechanical structure of a loudspeaker according to some embodiments of the present disclosure;

FIG. 2B is a schematic diagram of an exemplary structure of a loudspeaker according to some embodiments of the present disclosure;

FIG. 3 is a schematic diagram of exemplary frequency response curves of loudspeakers according to some embodiments of the present disclosure;

FIG. 4A is a schematic diagram of an exemplary three-dimensional (3D) structure of a cavity structure according to some embodiments of the present disclosure;

FIG. 4B is a schematic diagram of a B-B cross-section of the cavity structure in FIG. 4A;

FIG. 4C is a schematic diagram of an A-A cross-section of the cavity structure in FIG. 4A;

FIG. 4D is a schematic diagram of the cavity structure in FIG. 4A marking out a volume of a cavity;

FIG. 5 is a schematic diagram of exemplary frequency response curves of loudspeakers according to some embodiments of the present disclosure;

FIG. 6 is a schematic diagram of an exemplary structure of a loudspeaker according to some embodiments of the present disclosure;

FIG. 7A-FIG. 7C are schematic diagrams of exemplary C-C cross-sections of the cavity structure in FIG. 6;

FIG. 8 is a schematic diagram of an exemplary structure of a loudspeaker according to some embodiments of the present disclosure;

FIG. 9 is a schematic diagram of an exemplary structure of a loudspeaker according to some embodiments of the present disclosure;

FIG. 10 is a schematic diagram of an exemplary structure of a loudspeaker according to some embodiments of the present disclosure;

FIG. 11 is a schematic diagram of an exemplary structure of a loudspeaker according to some embodiments of the present disclosure;

FIG. 12 is a schematic diagram of an exemplary structure of a loudspeaker according to some embodiments of the present disclosure;

FIG. 13 is a schematic diagram of an exemplary structure of a loudspeaker according to some embodiments of the present disclosure;

FIG. 14A is a schematic diagram of an exemplary structure of a loudspeaker according to some embodiments of the present disclosure;

FIG. 14B is a schematic diagram of a C-C cross-section of a cavity structure in FIG. 14A;

FIG. 15A is a schematic diagram of an exemplary structure of a loudspeaker according to some embodiments of the present disclosure; and

FIG. 15B is a schematic diagram of a C-C cross-section of a cavity structure in FIG. 15A.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor. Unless otherwise indicated or stated in the context, the same reference numerals in the drawings represent the same structures or operations.

It should be understood that the terms “system,” “device,” “unit,” and/or “module” used in the present disclosure are a manner for distinguishing different components, elements, parts, portions, or assemblies at different levels. However, if other words can achieve the same purpose, they can be replaced with other expressions.

As indicated in the present disclosure and the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

In the description of the present disclosure, it is to be understood that the terms “first,” “second,” “third,” “fourth,” etc., are used for descriptive purposes only, and are not to be understood as indicating or implying relative importance or implicitly specifying the number of technical features indicated. Thereby, features with descriptive terms “first,” “second,” “third,” “fourth,” etc., may expressly or implicitly include at least one such feature. In the description of the present disclosure, “plurality” and “multiple” refer to at least two, e.g., two, three, or the like, unless otherwise expressly and specifically limited.

In the present disclosure, unless otherwise expressly specified or limited, the terms “connection,” “connected,” “fixing,” “fixed,” or the like shall be broadly construed. For example, the term “connection” may refer to a fixed connection, a removable connection, or a one-piece connection; a mechanical connection, an electrical connection, a direct connection, an indirect connection through an intermediate medium, a connection within two elements, or an interaction between two elements, unless expressly limited otherwise. To a person of ordinary skill in the art, the specific meanings of the above terms in the present disclosure may be understood on a case-by-case basis.

Embodiments of the present disclosure provide a loudspeaker that may include a diaphragm, a housing, and a cavity structure. The diaphragm may be configured to vibrate to generate air-conducted sound waves. The housing may be configured to form an accommodation cavity for housing the diaphragm. The diaphragm may divide the accommodation cavity to form a front cavity and a rear cavity. The housing may be provided with a sound outlet hole communicating with the front cavity, and at least a portion of the air-conducted sound waves may be transmitted through the sound outlet hole to an exterior of the loudspeaker. The housing may be provided with a cavity structure that is in communication with at least one of the front cavity and the rear cavity, and the cavity structure may be configured to absorb a sound wave with a target frequency in the air-conducted sound waves. In some embodiments, by configuring one or more parameters (e.g., a shape, a position, a size, etc.) of the cavity structure, the target frequency may be set at a particular frequency position, thereby making a frequency response curve of the loudspeaker flatter and improving an acoustic performance of the loudspeaker. Additionally, by configuring the cavity structure, it is possible to influence a mechanical vibration state of a vibration system in the loudspeaker, thereby adjusting the frequency response curve of the loudspeaker and achieving an inherent structural filtering effect for the loudspeaker.

The loudspeaker provided by the embodiments of the present disclosure is described in detail below in connection with the accompanying drawings.

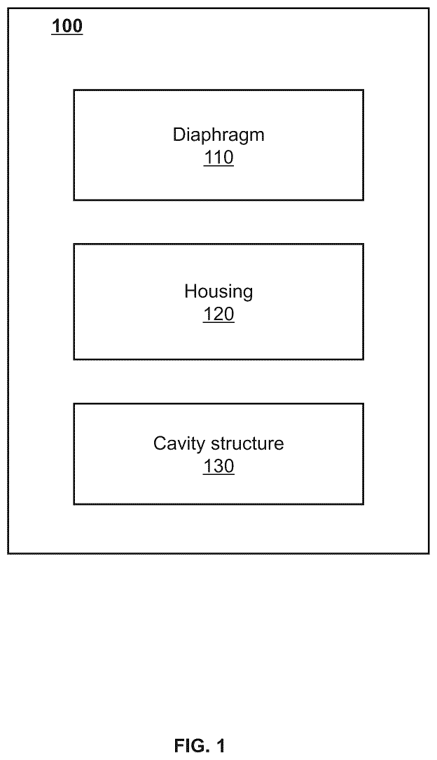

FIG. 1 is a block diagram of an exemplary loudspeaker according to some embodiments of the present disclosure. As shown in FIG. 1, the loudspeaker 100 may include a diaphragm 110, a housing 120, and a cavity structure 130.

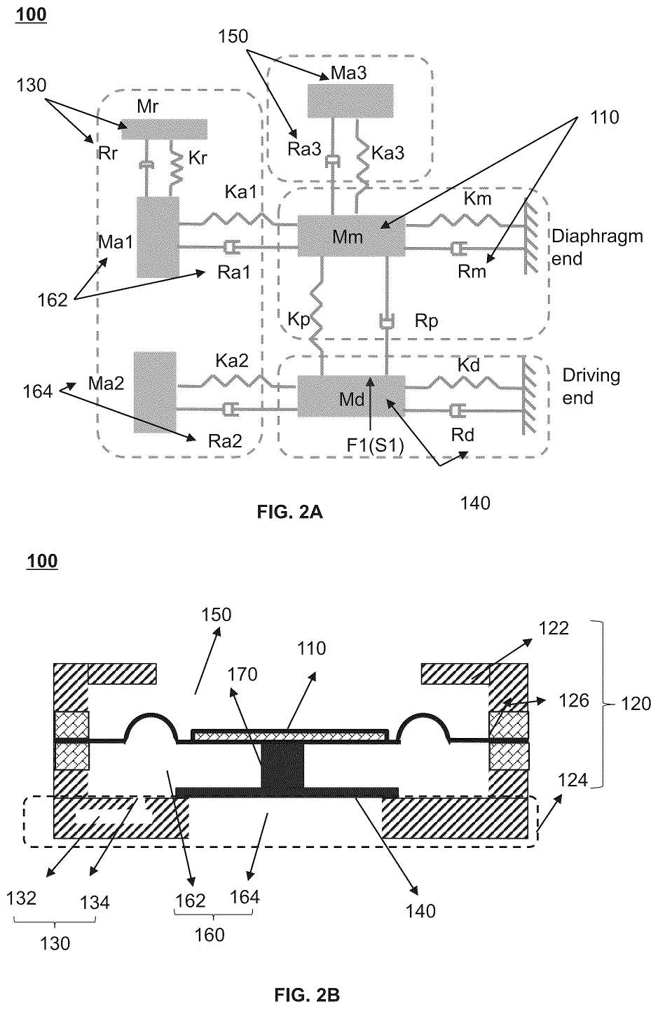

The diaphragm 110 may be configured to vibrate to generate air-conducted sound waves. In some embodiments, the diaphragm 110 may directly receive an electrical signal and convert the electrical signal into a vibration signal. For example, the diaphragm 110 may include a piezoelectric diaphragm, an electrostatically driven diaphragm, or the like. In other words, the diaphragm 110 is also a driving unit. In some embodiments, the loudspeaker 100 may include a driving unit (e.g., a driving unit 140 in FIG. 2B). The driving unit may be configured to receive an electrical signal and convert the electrical signal into a vibration signal. The driving unit may transmit the vibration signal, e.g., through vibration transmission unit, to the diaphragm 110, thereby driving the diaphragm 110 to vibrate. In some embodiments, the driving unit may include a moving coil driving unit, a moving iron driving unit, an electrostatic driving unit, a piezoelectric driving unit, or the like. For ease of description, the present disclosure is described with the diaphragm and the driving unit set up independently; however, this configuration manner does not limit the scope of the present application.

The housing 120 may form an accommodation cavity for housing other components (e.g., the diaphragm 110, the driving unit, etc.) of the loudspeaker 100. The diaphragm 110 may divide the accommodation cavity into a front cavity and a rear cavity. The housing 120 may be provided with a sound outlet hole that is communicated with the front cavity. At least a portion of the air-conducted sound waves generated by the vibration of the diaphragm 110 may be transmitted through the sound outlet hole to an exterior of the loudspeaker 100.

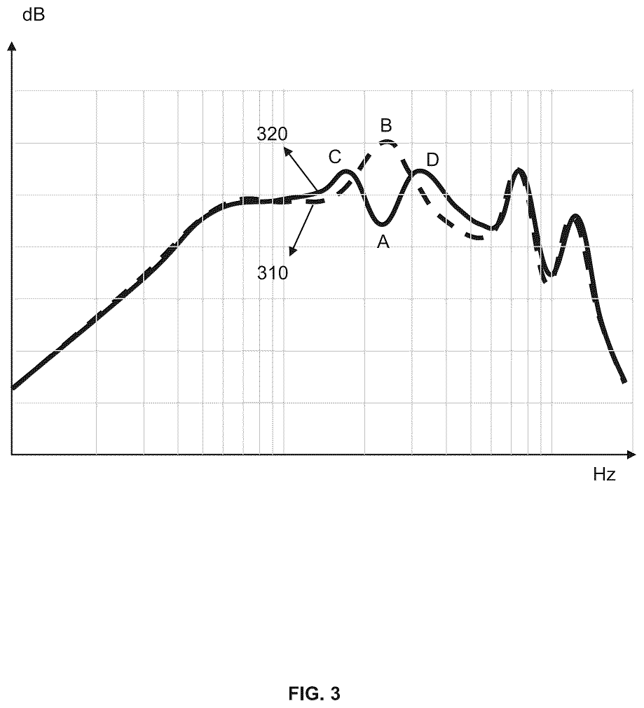

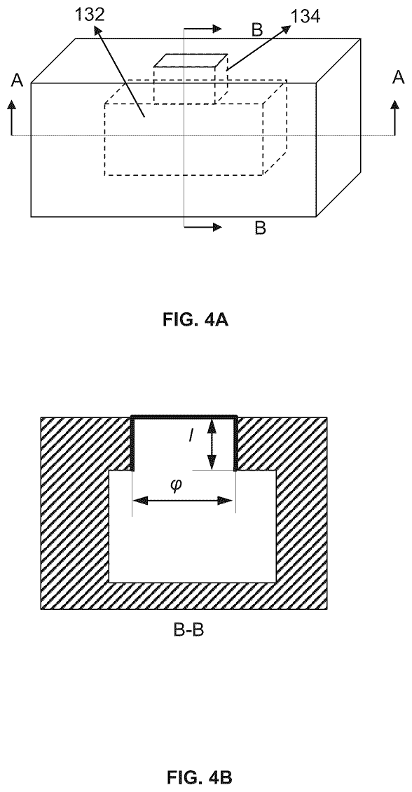

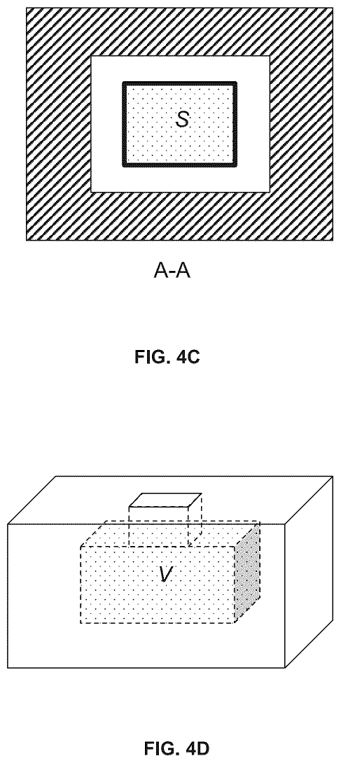

The housing 120 may be provided with a cavity structure 130. The cavity structure 130 may be in communication with at least one of the front cavity and the rear cavity of the housing 120. The cavity structure 130 may be configured to absorb a sound wave with a target frequency in the air-conducted sound waves generated by the diaphragm 110. In other words, the cavity structure 130 may have an acoustic absorption effect. More description of the cavity structure 130 may be found elsewhere in the present disclosure (e.g., FIG. 2A-FIG. 2B, FIG. 3, FIG. 4A-FIG. 4D, etc., and descriptions thereof).

FIG. 2A is a schematic diagram of an exemplary mechanical structure of a loudspeaker according to some embodiments of the present disclosure. FIG. 2B is a schematic diagram of an exemplary structure of a loudspeaker according to some embodiments of the present disclosure.

As shown in FIG. 2A and FIG. 2B, the loudspeaker 100 may include the diaphragm 110, the housing 120, the cavity structure 130, a driving unit 140, and a vibration transmission unit 170. The housing 120 may form an accommodation cavity for housing one or more components (e.g., the diaphragm 110, the driving unit 140, etc.) of the loudspeaker 100. The diaphragm 110 may divide the accommodation cavity into a front cavity 150 and a rear cavity 160. The driving unit 140 may perform an energy conversion to convert electrical energy (i.e., an electrical signal) into mechanical energy (i.e., a vibration signal) and transfer the mechanical energy to the diaphragm 110 via the vibration transmission unit 170. The diaphragm 110, driven by the driving unit 140, can vibrate and push air to generate air-conducted sound waves. At least a portion of the air-conducted sound waves may be transmitted through a sound outlet hole (not shown in the drawings) to an exterior of the loudspeaker 100.

In some embodiments, the housing 120 may include a front cavity plate 122, a rear cavity plate 124, and a side plate 126. The front cavity plate 122, the rear cavity plate 124, and the side plate 126 enclose the above-described accommodation cavity. In some embodiments, the front cavity plate 122, the rear cavity plate 124, and/or the side plate 126 may include a printed circuit board (PCB), a plastic plate, a metal plate, or the like, without limitation in the present disclosure.

In some embodiments, the driving unit 140 may be disposed in the rear cavity 160, as shown in FIG. 2B. In some embodiments, the rear cavity 160 may be divided or not divided based on an arrangement position of the driving unit 140. For example, for a piezoelectric loudspeaker, the driving unit 140 may be secured to the housing 120 (e.g., the rear cavity plate 124) of the loudspeaker by a perforated bracket so as not to divide the rear cavity 160. As another example, for an electromagnetic loudspeaker, a magnetic circuit portion thereof (i.e., the driving unit 140) may be secured to the housing 120 (e.g., the rear cavity plate 124) by a perforated bracket so as not to divide the rear cavity 160. As yet another example, as shown in FIG. 2B, the driving unit 140 may be secured to the rear cavity plate 124 and cooperate with the rear cavity plate 124 to divide the rear cavity 160 into a first rear cavity 162 and a second rear cavity 164. The first rear cavity 162 may be enclosed by at least a portion of the housing 120, the driving unit 140, and the vibration transmission unit 170. The second rear cavity 164 may be enclosed by the driving unit 140 and the rear cavity plate 124. The second rear cavity 164 may or may not be in communication with the exterior of the loudspeaker 100. For ease of description, the present application takes the arrangement in which the driving unit 140 can divide the rear cavity 160 as an example, which does not limit the scope of the present disclosure.

The cavity structure 130 may include an acoustic absorbing cavity 132 and a connecting hole 134. In some embodiments, the cavity structure 130 may be provided on the front cavity plate 122, the rear cavity plate 124, the side plate 126, or the like. Exemplarily, the cavity structure 130 may be in communication with the rear cavity 160. The cavity structure 130 may be provided on the rear cavity plate 124. A frequency response curve of the loudspeaker 100 may be adjusted by setting one or more parameters (e.g., a shape, a position, a size, etc.) of the cavity structure 130.

For example, as shown in FIG. 2A, the various portions of the loudspeaker 100 may be equated to a spring-mass-damping system. Specifically, the diaphragm 110 and the driving unit 140 are connected by an equivalent spring damping (i.e., spring (Kp)-damping (Rp)). Due to the presence of air in the front cavity 150 and the rear cavity 160, an air spring (Ka1)-mass (Ma1)-damping (Ra1) system formed by the first rear cavity 162 and a spring (Ka2)-mass (Ma2)-damping (Ra2) system formed by the second rear cavity 164 may act on the diaphragm 110 (which may be equated to a spring (Km)-mass (Mm)-damping (Rm) system) and the driving unit 140 (which may be equivalent to a spring (Kd)-mass (Md)-damping (Rd) system). The front cavity 150 may be equated to a spring (Ka3)-mass (Ma3)-damping (Ra3) system acting on the diaphragm 110.

In a case where the cavity structure 130 is not provided, due to a relatively small volume of the first rear cavity 162, the stiffness of the spring (Ka1) in the air spring (Ka1)-mass (Ma1)-damping (Ra1) system of the first rear cavity 162 is greater than the stiffness of the spring (Km) in the spring (Km)-mass (Mm)-damping (Rm) system of the diaphragm 110 and the stiffness of the spring (Kd) in the spring (Kd)-mass (Md)-damping (Rd) system of the driving unit 140. The first rear cavity 162 acts on the diaphragm 110 and the driving unit 140 in a form of an additional stiffness, which can reduce a vibrational displacement of the diaphragm 110 and the driving unit 140, and thus reduce an output of the loudspeaker. Therefore, the cavity structure 130 may be designed so that the frequency response curve of the loudspeaker can be adjusted by adjusting a resonant frequency of the spring-mass-damping system corresponding to the cavity structure 130, thereby improving an acoustic output effect.

Specifically, by designing the cavity structure 130 inside the loudspeaker 100, the cavity structure 130 may form a new air spring (Kr)-mass (Mr)-damping (Rr) system due to the presence of air. The air spring (Kr)-mass (Mr)-damping (Rr) system may resonate at its resonant frequency. Further, because the cavity structure 130 is a sealed cavity, a relatively large sound pressure is generated only in the acoustic absorbing cavity 132 when the cavity structure 130 resonates. At the same time, the sound pressure cannot be radiated outwardly to act on the diaphragm 110, so that the outwardly radiated sound pressure through the diaphragm 110 is reduced, which is manifested as a valley (e.g., the valley A in curve 320 shown in FIG. 3) in the frequency response curve of the loudspeaker 100, thereby realizing the adjustment of the frequency response curve of the loudspeaker 100. In some embodiments of the present disclosure, the frequency corresponding to the valley may also be equal to a target frequency.

In some embodiments, the target frequency (e.g., where the valley is located) may be adjusted by adjusting one or more parameters (e.g., the shape, the position, the size, etc.) of the cavity structure 130, to realize the valley in different frequency bands on the frequency response curve of the loudspeaker 100, so as to enable the loudspeaker 100 to meet actual demands and enhance user experience. More descriptions of the cavity structure 130 may be found in FIGS. 4A-4D of the present disclosure and the related descriptions thereof, which may not be repeated here.

FIG. 3 is a schematic diagram of exemplary frequency response curves of loudspeakers according to some embodiments of the present disclosure. As shown in FIG. 3, curve 310 represents a frequency response curve of a loudspeaker without a cavity structure. Curve 320 represents a frequency response curve of a loudspeaker having a cavity structure, such as the loudspeaker 100.

As may be seen from FIG. 3, for the loudspeaker without the cavity structure, the vibration of the diaphragm of the loudspeaker may have a corresponding resonant frequency (corresponding to the frequency corresponding to the resonance peak B of curve 310). The resonant frequency of the vibration of the diaphragm causes the frequency response curve of the loudspeaker without the cavity structure to be less flat. By configuring a cavity structure (e.g., the cavity structure 130) on a housing (e.g., the front cavity plate 122 or the rear cavity plate 124 of the housing 120) of the loudspeaker, it is possible to reduce the response of the frequency response curve of the loudspeaker at the target frequency due to a sound absorption effect of the cavity structure on sound waves at the target frequency. As shown in FIG. 3, setting a sound absorption frequency of the cavity structure (i.e., the target frequency) at the resonant frequency of the vibration of the diaphragm can effectively suppress the peak generated by the diaphragm's vibration at that frequency, and may even create a valley in the overall frequency response curve of the loudspeaker at the resonant frequency of the diaphragm.

By way of example only, for the loudspeaker having the cavity structure, the vibration of its diaphragm may have a corresponding primary resonant frequency (which may be approximated as the frequency corresponding to the resonance peak B of curve 310). In some embodiments, by designing one or more parameters (e.g., the shape, the position, the size, etc.) of the cavity structure, the target frequency of the cavity structure may be set near the primary resonant frequency of the diaphragm's vibration, which allows the peak value of the loudspeaker with the cavity structure at the primary resonant frequency to be significantly reduced, forming a valley, with two peaks (e.g., peaks C and D in FIG. 3) whose amplitudes are both lower than the peak value of the primary resonant frequency appearing on two sides of the valley, respectively, thereby improving the loudspeaker's overall sensitivity and flattening the frequency response curve. The amplitudes of the peaks C and D are both lower than the amplitude of the resonance peak B, an amplitude difference between peak C or D and resonance peak B may be greater than 6 dB, and an amplitude difference between valley A and resonance peak B may be greater than 12 dB. In some embodiments, a difference between the target frequency and the primary resonant frequency may be within 300 Hz. Preferably, the difference between the target frequency and the primary resonant frequency may be within 200 Hz. More preferably, the difference between the target frequency and the primary resonant frequency may be within 100 Hz. More preferably, the target frequency may be equal to the primary resonant frequency.

In some embodiments, the frequency response curve of the loudspeaker is usually relatively smooth in middle and low frequency bands, while middle and high frequency bands are affected by higher-order modes of the diaphragm and the driving unit of the loudspeaker and a mode of the cavity, which may form a relatively large count of resonance peaks. Therefore, in order to make the frequency response curve of the loudspeaker smoother in the middle and high frequency bands, the corresponding cavity structure may be designed so that the target frequency is located in the middle and high frequency bands. In some embodiments, the target frequency may be in a range of 1 kHz-20 kHz. In some embodiments, the target frequency may be in a range of 3 kHz-20 kHz. In some embodiments, the target frequency may be in a range of 3 kHz-10 kHz. In some embodiments, the target frequency may be in a range of 3 kHz-8 kHz.

As shown in FIG. 3, the frequency response curve of the loudspeaker with the cavity structure is flatter than the frequency response curve of the loudspeaker without the cavity structure, which makes the loudspeaker with the cavity structure has a better acoustics effect. In some embodiments, a depth of the valley may be further adjusted by adjusting the damping of one or more components (e.g., the cavity structure 130) of the loudspeaker to flatten the frequency response curve of the loudspeaker, thereby further improving the acoustic effect of the loudspeaker.

FIG. 4A is a schematic diagram of an exemplary three-dimensional (3D) structure of a cavity structure according to some embodiments of the present disclosure. FIG. 4B is a schematic diagram of a B-B cross-section of the cavity structure in FIG. 4A. FIG. 4C is a schematic diagram of an A-A cross-section of the cavity structure in FIG. 4A. FIG. 4D is a schematic diagram of the cavity structure in FIG. 4A marking out a volume of a cavity.

In some embodiments, the cavity structure 130 may include an acoustic absorbing cavity 132 and a connecting hole 134, as shown in FIG. 4A. By designing a size (e.g., a size of the acoustic absorbing cavity 132 and a size of the connecting hole 134), a shape, etc., of the cavity structure 130, a sound-absorbing effect may be achieved in different frequency ranges, thereby creating valleys at various points on the frequency response curve of the loudspeaker 100.

In some embodiments, as shown in FIG. 4B-FIG. 4D, an equivalent diameter of the connecting hole 134 is φ, a length of the connecting hole 134 is l, a transverse area of the connecting hole 134 is S, and a volume of the acoustic absorbing cavity 132 is V. The location (or the target frequency) of the valley created by the cavity structure 130 may be adjusted by adjusting a value range of the parameter θ, which in turn adjusts the acoustic output of the loudspeaker. The parameter θ may be determined according to the following Equation (1):

$$θ = \frac{S}{l * V} \qquad ( 1 )$$

The larger the value of the parameter θ corresponding to the cavity structure 130, the larger the corresponding target frequency. In order to keep the location of the valley between 1 kHz and 20 kHz, the range of parameter θ may be 1000 (1/m²)-40000 (1/m²). In some embodiments, in order to keep the location of the valley between 2 kHz and 10 kHz, the range of parameter θ may be 2000 (1/m²) to 35000 (1/m²).

In some embodiments, a magnitude of the equivalent diameter q of the connecting hole 134 affects an acoustic resistance, and thus affects the valley formed by the cavity structure 130. For example, a value of o that is too small may result in a high acoustic resistance, rendering the cavity structure 130 ineffective at absorbing sound. In some embodiments, in order to ensure that the cavity structure 130 has an acoustic absorption effect, the equivalent diameter of the connecting hole 134 may be not less than 0.05 mm. Preferably, the equivalent diameter of the connecting hole 134 may be not less than 0.1 mm.

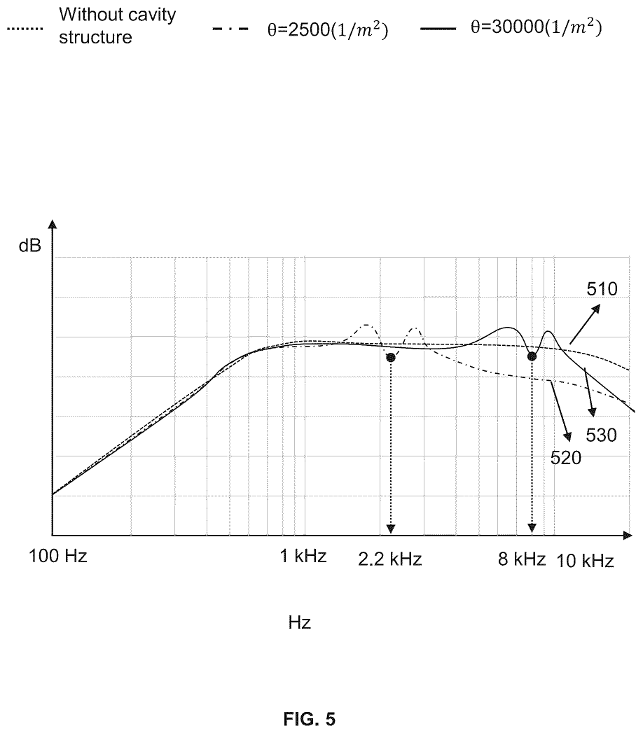

FIG. 5 is a schematic diagram of exemplary frequency response curves of loudspeakers according to some embodiments of the present disclosure. As shown in FIG. 5, curve 510 represents a frequency response curve of a loudspeaker without a cavity structure. Curve 520 represents a frequency response curve of a loudspeaker with a cavity structure and a parameter θ=2500 (1/m²). Curve 530 represents a frequency response curve of a loudspeaker with a cavity structure and a parameter θ=30000 (1/m²).

As can be seen from FIG. 5, compared to the loudspeaker without the cavity structure (corresponding to curve 510), by providing the cavity structure 130 (corresponding to curve 520 or curve 530) in the housing 120 of the loudspeaker, a valley may be formed at a specific frequency, and two peaks may be formed to the left and the right of the valley, thereby enhancing the sensitivity of the loudspeaker. Further, by adjusting one or more parameters of the cavity structure, the valley (or the target frequency) may be set at different locations, e.g., by adjusting the value of the parameter θ of the cavity structure, valleys may be formed near 2.2 kHz of curve 520 and near 8 kHz of curve 530, respectively.

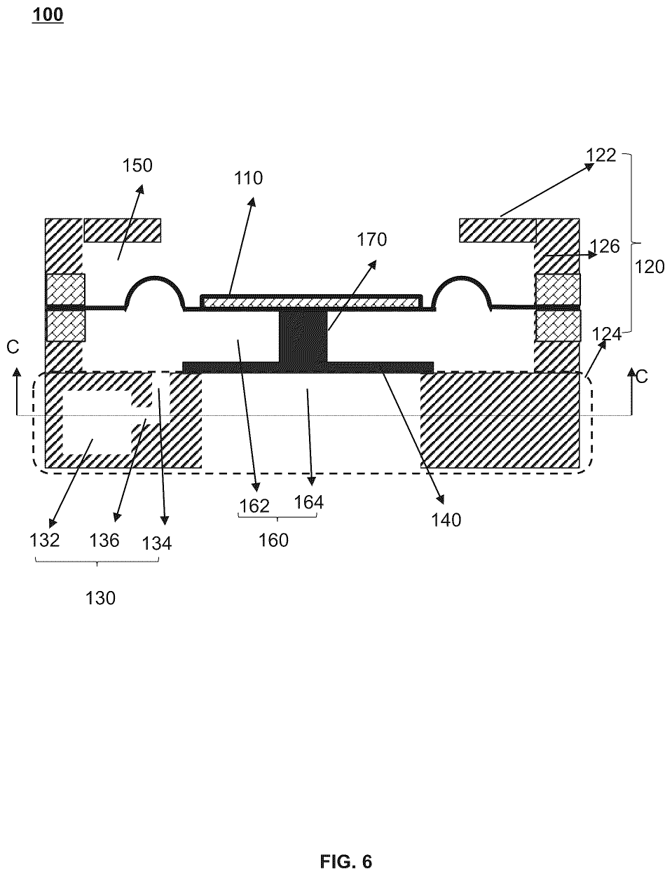

FIG. 6 is a schematic diagram of an exemplary structure of a loudspeaker according to some embodiments of the present disclosure.

In some embodiments, the cavity structure 130 may further include a sound guiding tube 136, as shown in FIG. 6. The connecting hole 134 may be connected to the acoustic absorbing cavity 132 via the sound guiding tube 136. The cavity structure 130 may be made more flexible by providing the sound guiding tube 136. For example, the acoustic absorbing cavity 132 may be spaced apart from the connecting hole 134 by providing the sound guiding tube 136, for example, the acoustic absorbing cavity 132 may be provided on the rear cavity plate 124, and the connecting hole 134 may be provided on the side plate 126, and then the acoustic absorbing cavity 132 is connected to the connecting hole 134 via the sound guiding tube 136, so as to adjust the frequency response of the loudspeaker. In some embodiments, in order for the cavity structure 130 to achieve a sound-absorbing effect, an equivalent diameter of the sound guiding tube 136 may be not less than 0.05 mm. Preferably, the equivalent diameter of the sound guiding tube 136 may be no less than 0.1 mm.

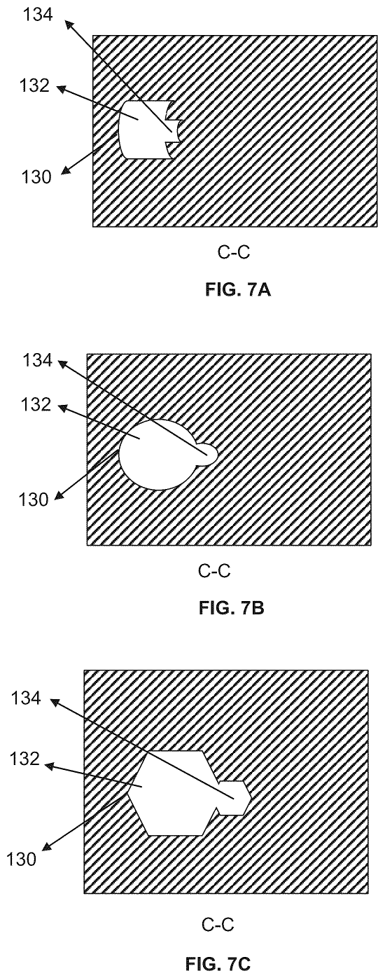

FIG. 7A-FIG. 7C are schematic diagrams of a C-C cross-section of a cavity structure in FIG. 6. In some embodiments, shapes of the acoustic absorbing cavity 132, the connecting hole 134, and/or the sound guiding tube 136 included in the cavity structure 130 may be configured according to the size of actual space. In some embodiments, as shown in FIG. 7A-FIG. 7C, the shapes of the acoustic absorbing cavity 132, the connecting hole 134, and/or the sound guiding tube 136 may be one of a square, a circle, an ellipse, a polygon, an irregular shape, or a combination thereof.

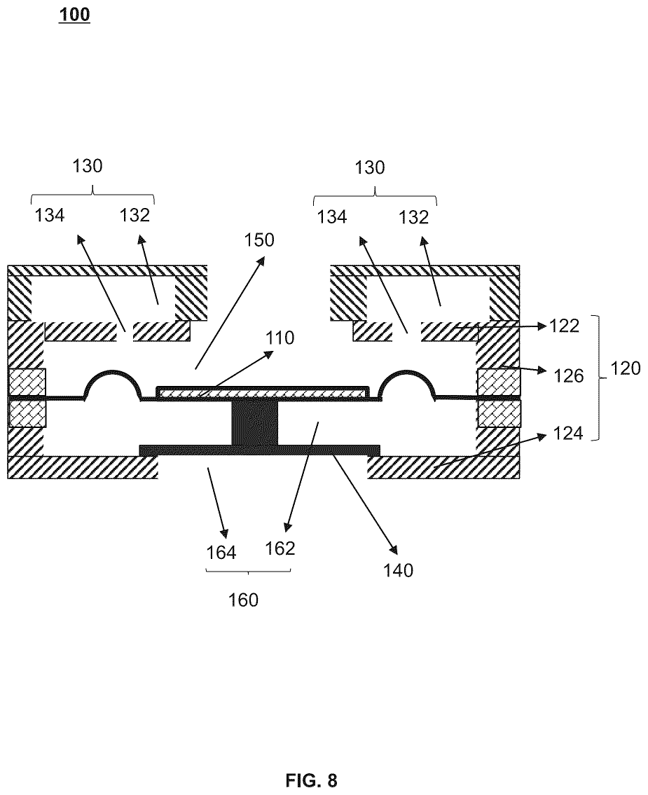

FIG. 8 is a schematic diagram of an exemplary structure of a loudspeaker according to some embodiments of the present disclosure.

In some embodiments, the cavity structure 130 may be provided at the front cavity plate 122, as shown in FIG. 8. The cavity structure 130 may be communicated with the front cavity 150 via the connecting hole 134. By providing the cavity structure 130 at the front cavity plate 122, the cavity structure 130 may not only affect a vibration state of the vibration system of the loudspeaker, but also directly absorb part of air-conducted sound waves generated by the vibration of the diaphragm 110, thereby affecting the acoustic performance of the loudspeaker 100. In the present disclosure, the direct absorption refers to an impact of the cavity structure 130 on the air-conducted sound waves produced by the loudspeaker as the air-conducted sound waves are transmitted to the sound outlet hole. This is because the cavity structure 130 is in communication with the front cavity 150. Compared to the rear cavity plate 124, providing the cavity structure 130 at the front cavity plate 122 is simpler and more convenient, facilitating subsequent assembly. In some embodiments, the front cavity 150 may be in communication with the sound outlet hole via a sound guiding channel (not shown). The cavity structure 130 may be in communication with the sound guiding channel through the front cavity 150. In other words, the cavity structure 130 is in communication with the sound outlet hole through the front cavity 150 and the sound guiding channel.

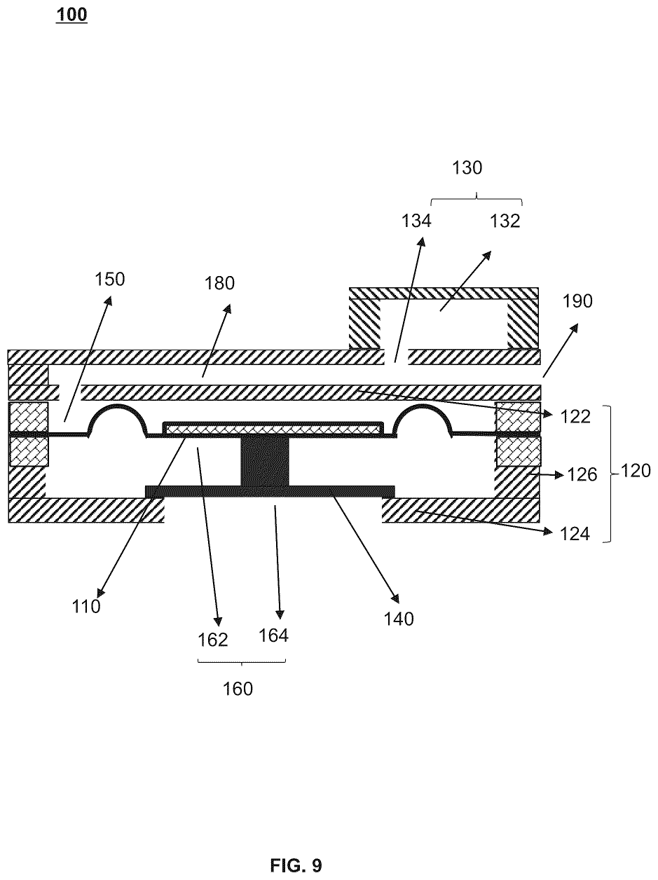

FIG. 9 is a schematic diagram of an exemplary structure of a loudspeaker according to some embodiments of the present disclosure.

In some embodiments, the front cavity 150 of the housing 120 of the loudspeaker may be in communication with a sound outlet hole 190 through a sound guiding channel 180. The cavity structure may be provided in the sound guiding channel 180, i.e., the cavity structure 130 may be in communication with the front cavity 150 via the sound guiding channel 180. In other words, the cavity structure 130 is in communication with the sound outlet hole through the sound guiding channel only. Providing the cavity structure 130 in the sound guiding channel 180 results in a more simple and convenient design, facilitating subsequent assembly. For example, different sound guiding channels provided with different cavity structures may be used as accessories, and components other than the sound guiding channel assembled with the cavity structure may be used as base components. For a same base component, different accessories may be assembled thereto, so as to realize different adjustments to the frequency response of the loudspeaker, and make the loudspeaker adaptable to different application scenarios.

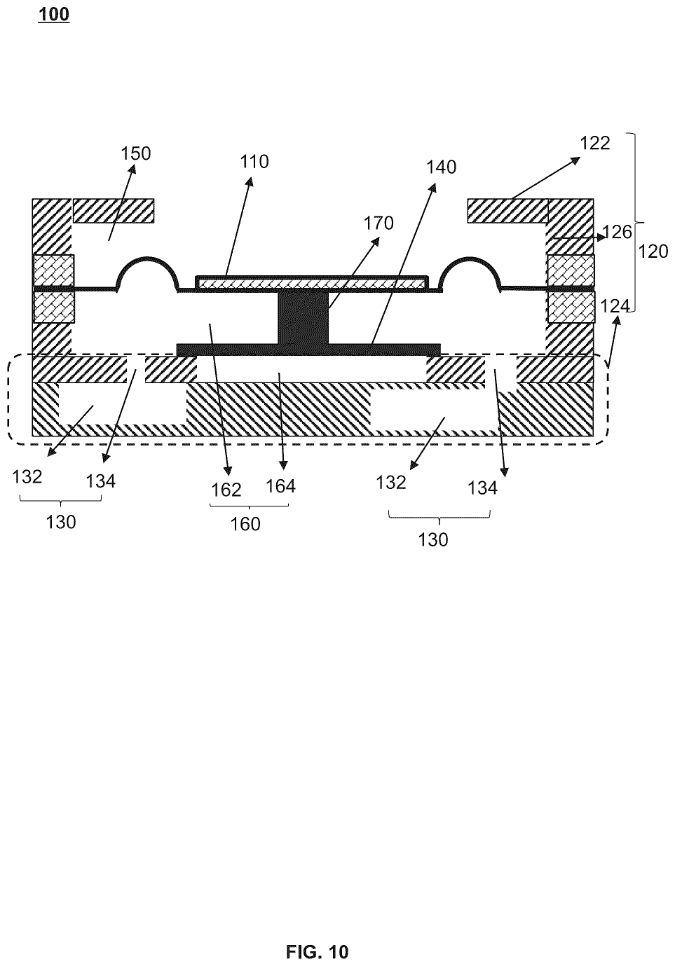

FIG. 10 is a schematic diagram of an exemplary structure of a loudspeaker according to some embodiments of the present disclosure.

In some embodiments, the driving unit 140 may cooperate with the rear cavity plate 124 such that the second rear cavity 164 is not in communication with an exterior of the loudspeaker, as shown in FIG. 10. Specifically, the rear cavity plate 124 may be a groove structure, and the driving unit 140 may be disposed above the groove, so that the second rear cavity 164 enclosed by the driving unit 140 and the rear cavity plate 124 is not in communication with the exterior of the loudspeaker.

In some embodiments, the loudspeaker 100 may include at least two cavity structures 130. The at least two cavity structures 130 may be configured to absorb air-conducted sound waves of the same or different frequencies in the air-conducted sound waves. In other words, the at least two cavity structures 130 may correspond to the same or different target frequencies. For example, the target frequencies corresponding to the at least two cavity structures 130 may correspond to the frequencies corresponding to higher-order modes of the diaphragm 110 and the driving unit 140, respectively, so that the loudspeaker 100 has a flatter frequency response in a relatively high frequency band (e.g., 3 kHz-10 kHz), thereby improving an acoustic output of the loudspeaker.

In some embodiments, the at least two cavity structures 130 may be disposed at different locations of the loudspeaker 100. For example, the at least two cavity structures 130 may be provided on the rear cavity plate 124. As another example, one of the at least two cavity structures 130 may be disposed on the rear cavity plate 124, and the rest cavity structures 130 may be disposed on the front cavity plate 122. As yet another example, one of the at least two cavity structures 130 may be disposed on a wall of the acoustic guiding channel, another one of the at least two cavity structures 130 may be disposed on the front cavity plate 122, and the rest of the at least two cavity structures 130 may be disposed on the rear cavity plate 124.

In some embodiments, when the at least two cavity structures 130 are arranged on the rear cavity plate 124, and if the cavity structures 130 are placed in a localized position on the rear cavity plate 124, the cavity structures 130 locally affect a motion state of the diaphragm 110. This may lead to an imbalance of air stiffness within the rear cavity 160 (e.g., the first rear cavity 162), causing the diaphragm 110 to tilt, which results in resonance peaks of higher-order modes on the loudspeaker's frequency response curve, thereby reducing the speaker's acoustic output performance. Therefore, to avoid unnecessary higher-order modes in the loudspeaker 100, the at least two cavity structures 130 may be arranged symmetrically (or approximately symmetrically) with respect to a central axis of the loudspeaker 100 (for example, center points of the acoustic absorbing cavities are symmetrically distributed along the central axis of the loudspeaker). Additionally, by arranging the at least two cavity structures 130 symmetrically along the central axis of the loudspeaker 100, a structure of the rear cavity plate 124 (or the front cavity plate 122) can be made more reliable, thus extending the lifespan of the loudspeaker. By way of example, as shown in FIG. 10, the loudspeaker 100 may include two cavity structures 130. The two cavity structures 130 may be located on two sides of the central axis of the loudspeaker. Furthermore, the two cavity structures 130 may be symmetrically arranged around the central axis of the loudspeaker 100 within the rear cavity plate 124. The two cavity structures 130 are only in communication with the first rear cavity 162 and not in communication with the second rear cavity 164.

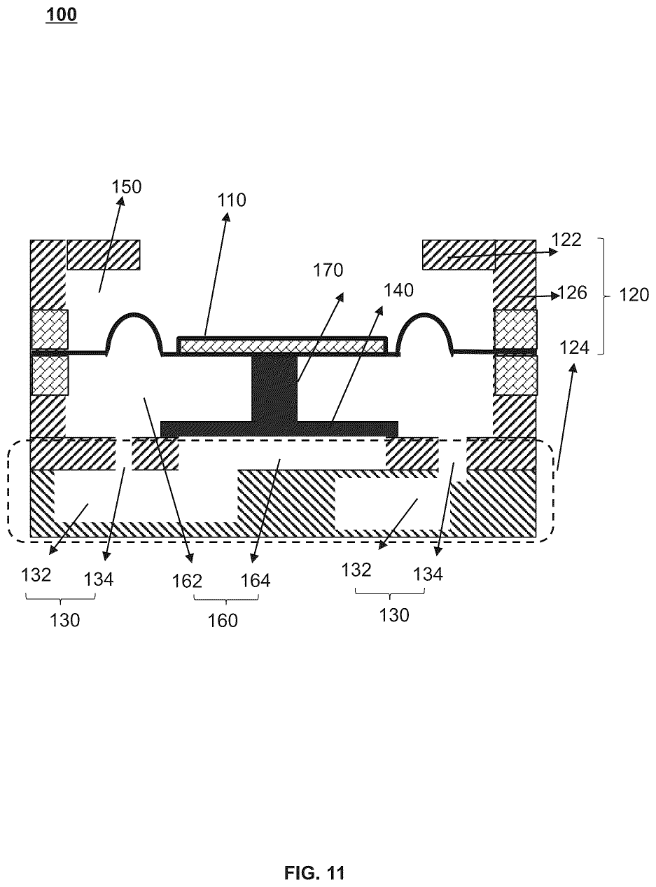

FIG. 11 is a schematic diagram of an exemplary structure of a loudspeaker according to some embodiments of the present disclosure.

In some embodiments, at least one of the at least two cavity structures 130 may be in communication with the first rear cavity 162 and the second rear cavity 164. By configuring the second rear cavity 164 to be in communication with the acoustic absorbing cavity 132 of at least one cavity structure 130, it is possible to facilitate adjusting a size of the acoustic absorbing cavity 132 of the at least one cavity structure 130 while increasing an adjustable range of the target frequency corresponding to the at least one cavity structure 130, thereby enhancing the adaptability of the loudspeaker 100. In addition, the acoustic absorbing cavity 132 of the cavity structure 130 is directly in communication with the second rear cavity 164, and an equivalent air spring-mass-damping system of the cavity structure 130 is equivalent to an air spring-mass-damping system that directly acts upon the driving unit 140, thereby allowing the vibration of the driving unit 140 to be adjusted. Thereby, the vibration effect of the driving unit 140 may be adjusted, thus achieving a built-in filtering effect of the loudspeaker. Exemplarily, as shown in FIG. 11, the left cavity structure 130 is in communication with both the first rear cavity 162 and the second rear cavity 164, while the right cavity structure 130 is only in communication with the first rear cavity 162. In some alternative embodiments, the right cavity structure 130 may also be in communication with the second rear cavity 164. In this case, at least one cavity structure 130 can achieve inter-communication through the second rear cavity 164, further increasing the size of the acoustic absorbing cavity 132.

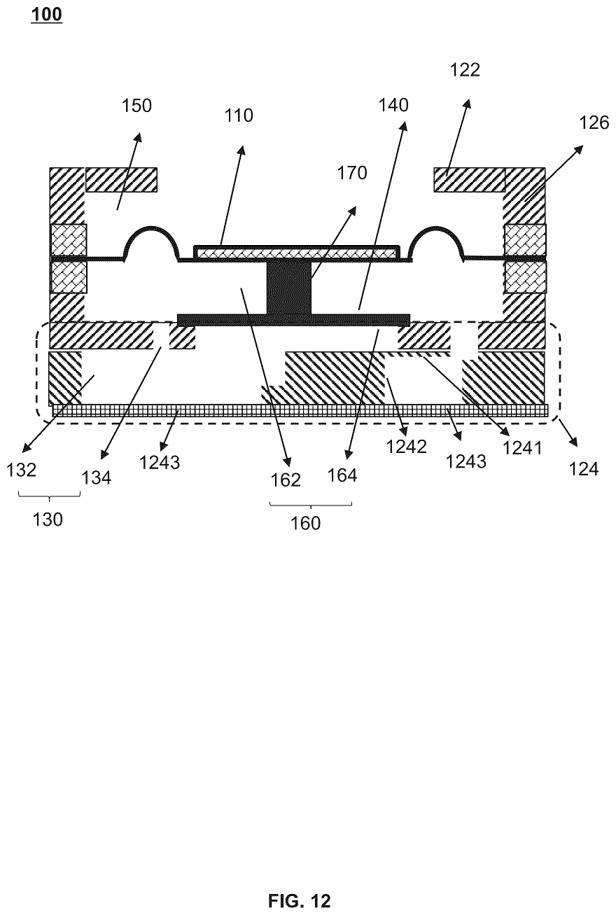

FIG. 12 is a schematic diagram of an exemplary structure of a loudspeaker according to some embodiments of the present disclosure.

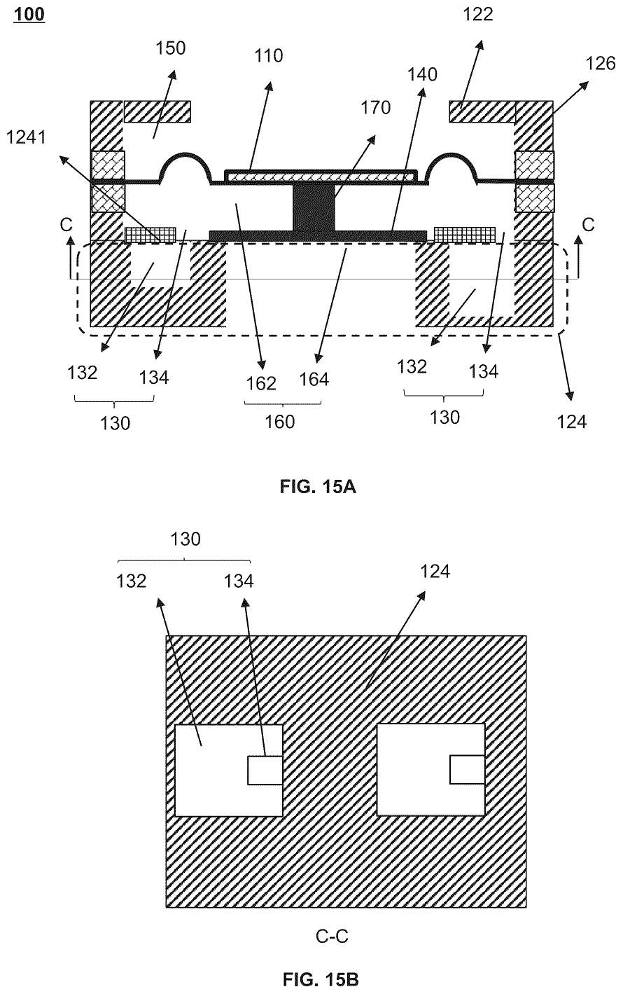

In some embodiments, the rear cavity plate 124 may include a front cavity wall 1241, a side cavity wall 1242, and a back plate 1243 that form the cavity structure 130, as shown in FIG. 12. In some embodiments, the target frequency of the cavity structure 130 may be further adjusted by setting a material of the front cavity wall 1241, the side cavity wall 1242, and/or the back plate 1243 of the cavity structure 130. For example, the back plate 1243 may be a damping mesh, as shown in FIG. 12. As another example, as shown in FIG. 15A, the front cavity wall 1241 may be a damping mesh. The damping mesh has a certain amount of air permeability, which, when used as the back plate or the front cavity wall, is equivalent to adding an additional acoustic absorbing cavity, which may be fine-tuned to the target frequency of the cavity structure 130. In addition, the damping mesh reduces a quality factor (i.e., Q) of the loudspeaker, thereby reducing a depth of a valley generated by the cavity structure 130 and resulting in a flatter frequency response curve of the loudspeaker 100.

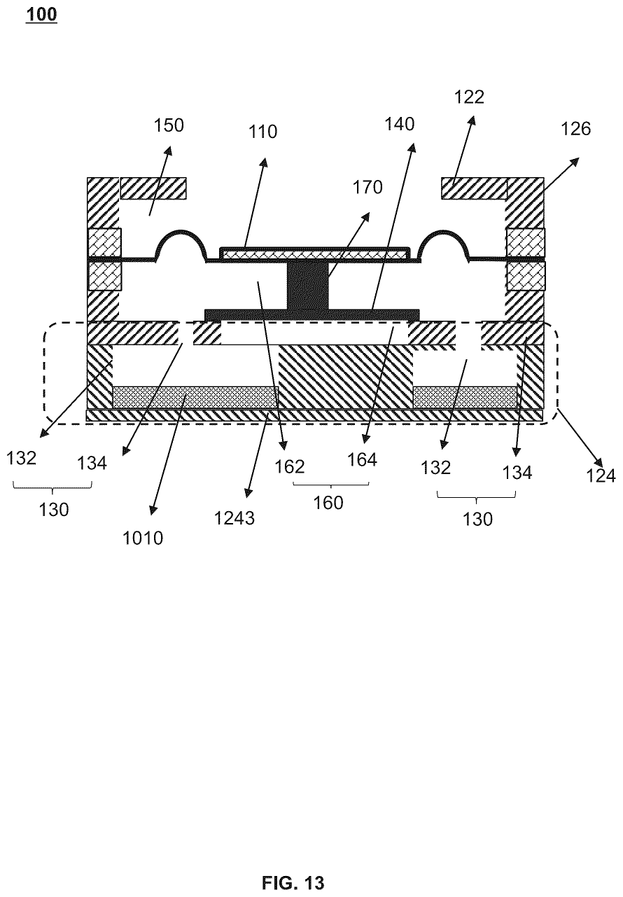

FIG. 13 is a schematic diagram of an exemplary structure of a loudspeaker according to some embodiments of the present disclosure.

In some embodiments, the back plate 1243 may be provided with a sound-absorbing material 1010, as shown in FIG. 13. By providing the sound-absorbing material 1010 on the back plate 1243, the bandwidth and the Q-value of the valley formed by the cavity structure 130 may be adjusted so that the valley generated by the cavity structure 130 is shallower, thereby further flattening the frequency response curve of the loudspeaker 100.

In some embodiments, the sound-absorbing material 1010 may include foam sponges (e.g., acoustic cotton), ceramic adsorbent particles (e.g., zeolite-type ceramic porous materials), carbon nanotube-type sound-absorbent materials, or the like. Structures based on these acoustic materials absorb and dissipate cavity resonance standing waves, making the sound quality of the loudspeaker better.

In some embodiments, the sound-absorbing material 1010 may include porous foam, porous spheres, or the like. A virtual volume of the acoustic absorbing cavity 132 may be increased by setting the sound-absorbing material 1010, which in turn enables the adjustment of the performance of the loudspeaker. Additionally, since the sound-absorbing material 1010 can increase the virtual volume of the acoustic absorbing cavity 132, the size of the loudspeaker may be further reduced under the same acoustic output effect of the loudspeaker, so that the loudspeaker 100 can adapt to more application scenarios.

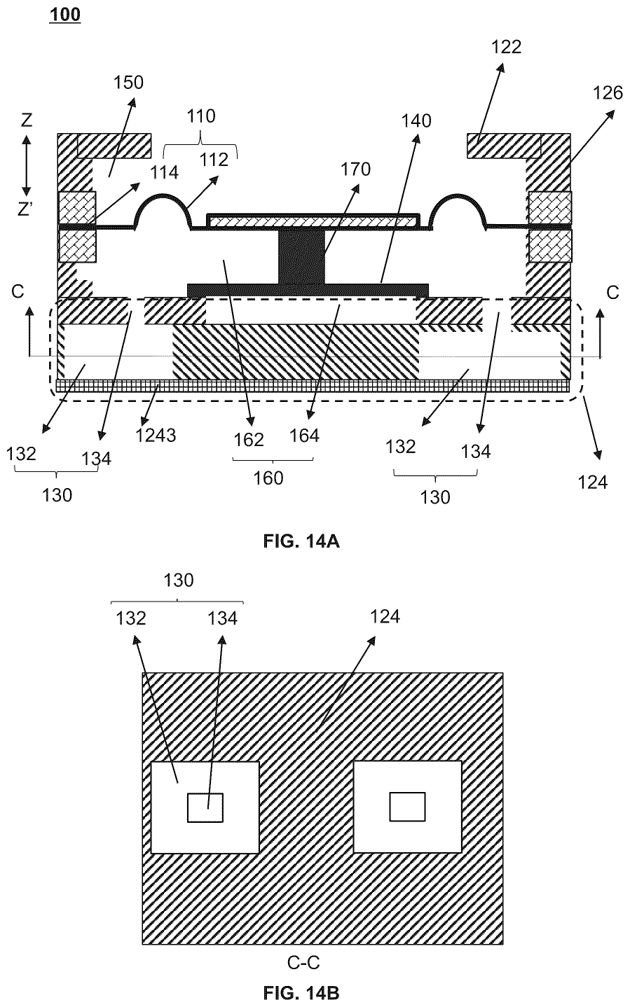

FIG. 14A is a schematic diagram of an exemplary structure of a loudspeaker according to some embodiments of the present disclosure. FIG. 14B is a schematic diagram of a C-C cross-section of a cavity structure in FIG. 14A.

In some embodiments, as shown in FIG. 14A-FIG. 14B, the connecting hole 134 may be located within a projection of the diaphragm 110 along a vibration direction (i.e., the direction ZZ′) of the diaphragm 110. In other words, the cavity structure 130 may affect air near the diaphragm 110 through the connecting hole 134. Thus, the localized air in different portions of the diaphragm 110 may be influenced by setting the position of the connecting hole 134, thereby changing a state of the diaphragm 110, and thus making the diaphragm's vibration more in line with usage requirements of the loudspeaker.

In some embodiments, the diaphragm 110 may include a folded-ring portion 112 and a fixed end 114, as shown in FIG. 14A. In some embodiments, the connecting hole 134 may be provided at a location near the folded-ring portion 112 of the diaphragm 110. For example, the connecting hole 134 may be arranged directly opposite to the folded-ring portion 112 of the diaphragm 110. Generally speaking, the closer a portion of the diaphragm 110 is to the folded-ring portion 112, the lower the stiffness of the portion is, while the closer the portion is to the fixed end 114, the higher the stiffness of the portion is. Therefore, the closer the connecting hole 134 is to an edge of the fixed end 114, the smaller its effect on the diaphragm 110; the closer the connecting hole 134 is to a center of the folded-ring portion 112, the greater its effect on the diaphragm 110. By positioning the connecting hole 134 near the folded-ring portion 112, the cavity structure 130 can affect the local air near the folded-ring portion 112, thereby more easily influencing the vibration state of the diaphragm 110, which facilitates adjusting the acoustic performance of the loudspeaker 100. In some embodiments, when a relatively small impact of the cavity structure 130 on the vibration of the diaphragm 110 is desired, the connecting hole 134 may be positioned near the fixed end 114 of the diaphragm 110. By positioning the connecting hole 134 near the fixed end 114, the cavity structure 130 has less influence on the local air near the folded-ring portion 112, thus reducing the impact of the cavity structure 130 on the vibration state of the diaphragm 110, enabling fine-tuning of the acoustic performance of the loudspeaker 100.

In some embodiments, as shown in FIG. 14A-FIG. 14B, the projection contour of the connecting hole 134 in the C-C cross-section may be located within the projection contour of the cavity structure 130 in the C-C cross-section, and the projection of the connecting hole 134 is not in contact with the projected contour of the cavity structure 130, so that the connecting hole 134 of the cavity structure 130 may be provided close to the folded-ring portion 112 of the diaphragm 110.

FIG. 15A is a schematic diagram of an exemplary structure of a loudspeaker according to some embodiments of the present disclosure. FIG. 15B is a schematic diagram of a C-C cross-section of a cavity structure in FIG. 15A.

In some embodiments, the front cavity wall 1241 of the cavity structure 130 may be a damping mesh, as shown in FIG. 15A. The Q-value of the cavity structure 130 may be adjusted by adopting damping materials with different acoustic resistance coefficients, so as to make the frequency response curve of the loudspeaker smoother to meet the needs in different scenarios. In some embodiments, as shown in FIG. 15A-FIG. 15B, a contour of a projection of the connecting hole 134 in the C-C cross-section may be located within a contour of a projection of the acoustic absorbing cavity 132 in the C-C cross-section, and the contour of the projection of the connecting hole 134 overlaps at least one edge of the contour of the projection of the acoustic absorbing cavity 132, such that the connecting hole 134 of the cavity structure 130 may be provided close to the fixed end 114 of the diaphragm 110.

It should be noted that in some embodiments, the arrangement of the cavity structure on the rear cavity plate described in the present disclosure may also be applied to or replaced with an arrangement on the front cavity plate or the side plate. For example, if the cavity structure is arranged on the front cavity plate, the front cavity wall or the back plate of the acoustic absorbing cavity may be set as a damping mesh, or the sound-absorbing material may be placed within the acoustic absorbing cavity. As another example, if the cavity structure is arranged on the front cavity plate, its connecting hole may be positioned near the folded-ring portion of the diaphragm.

The beneficial effects that may result from the embodiments described in the present disclosure may include, but are not limited to the following. (1) By arranging the cavity structure on the housing of the loudspeaker, a valley in the frequency response curve of the loudspeaker is produced, allowing the loudspeaker to directly emit sound with an adjusted frequency response, achieving the built-in filtering effect of the loudspeaker. (2) By adjusting the shape, the position, the size, etc., of the cavity structure, the target frequency corresponding to the cavity structure matches or approximates the primary resonant frequency of the diaphragm, thereby flattening the frequency response curve of the loudspeaker and improving the acoustic performance of the loudspeaker. (3) By placing the cavity structure within the front cavity plate and/or the rear cavity plate, and incorporating the damping mesh, the sound-absorbing material, etc., the frequency response curve of the loudspeaker is further flattened, thereby further enhancing the acoustic performance of the loudspeaker. (4) By arranging multiple cavity structures symmetrically (or approximately symmetrically) with respect to the central axis of the loudspeaker, the reliability of the housing of the loudspeaker is improved, and the processing cost of the loudspeaker is reduced. It should be noted that different embodiments may yield different beneficial effects, and in different embodiments, the potential beneficial effects may be any combination of the aforementioned or any other possible beneficial effects.

Having thus described the basic concepts, it may be rather apparent to those skilled in the art after reading this detailed disclosure that the foregoing detailed disclosure is intended to be presented as illustrative example and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of the present disclosure.

What is claimed is:

1. A loudspeaker comprising:
a diaphragm configured to vibrate to produce air-conducted sound waves; and
a housing configured to form an accommodation cavity for housing the diaphragm, wherein the diaphragm divides the accommodation cavity into a front cavity and a rear cavity, the housing is provided with a sound outlet hole communicating with the front cavity, and at least a portion of the air-conducted sound waves is transmitted through the sound outlet hole to an exterior of the loudspeaker, wherein
a cavity structure is provided on the housing and communicated with at least one of the front cavity and the rear cavity, and the cavity structure is configured to absorb a sound wave with a target frequency in the air-conducted sound waves, wherein the target frequency is in a range of 3 kHz-20 kHz.

2. The loudspeaker of claim 1, wherein vibration of the diaphragm has a primary resonant frequency, a difference between the primary resonant frequency and the target frequency being within 300 Hz.

3. The loudspeaker of claim 1, wherein the front cavity is communicated with the sound outlet hole through a sound guiding channel, and the cavity structure is communicated with the sound guiding channel through the front cavity.

4. The loudspeaker of claim 1, wherein the housing includes a front cavity plate, a rear cavity plate, and a side plate, and the cavity structure includes a connecting hole and an acoustic absorbing cavity.

5. The loudspeaker of claim 4, wherein the connecting hole is communicated with the acoustic absorbing cavity through a sound guiding tube.

6. The loudspeaker of claim 5, wherein an equivalent diameter of the sound guiding tube is not less than 0.05 mm.

7. The loudspeaker of claim 4, wherein an equivalent diameter of the connecting hole is not less than 0.1 mm.

8. The loudspeaker of claim 4, wherein a parameter e takes a value in a range of 1000 (1/m²)-40000 (1/m²), wherein:
$$θ = \frac{S}{l * V}$$
where S denotes a transverse area of the connecting hole, l denotes a length of the connecting hole, and V denotes a volume of the acoustic absorbing cavity.

9. The loudspeaker of claim 4, wherein the cavity structure is disposed in the rear cavity plate, the rear cavity plate includes a front cavity wall, a side cavity wall, and a back plate that form the cavity structure, wherein at least one of the front cavity wall, the side cavity wall, or the back plate includes a damping mesh.

10. The loudspeaker of claim 4, wherein the connecting hole is disposed within a projection of the diaphragm along a vibration direction of the diaphragm.

11. The loudspeaker of claim 4, wherein the diaphragm includes a folded-ring portion and a fixed end, and the connecting hole is arranged directly opposite to the folded-ring portion of the diaphragm.

12. The loudspeaker of claim 4, further comprising
a driving unit configured to generate vibration based on an electrical signal and drive the diaphragm to vibrate, wherein
the driving unit is provided in the rear cavity,
the driving unit cooperates with the rear cavity plate to divide the rear cavity into a first rear cavity and a second rear cavity, and
the second rear cavity is composed of the driving unit and the rear cavity plate.

13. The loudspeaker of claim 12, wherein the cavity structure is in communication with the first rear cavity but not in communication with the second rear cavity.

14. The loudspeaker of claim 12, wherein the cavity structure is in communication with the first rear cavity and the second rear cavity.

15. The loudspeaker of claim 12, wherein the cavity structure includes at least two cavity structures, wherein
a portion of the at least two cavity structures is in communication with the first rear cavity but not in communication with the second rear cavity, and
the other portion of the at least two cavity structures is in communication with the first rear cavity and the second rear cavity.

16. The loudspeaker of claim 4, wherein the cavity structure is provided in the front cavity plate.

17. The loudspeaker of claim 1, wherein the cavity structure includes at least two cavity structures arranged symmetrically with respect to a central axis of the loudspeaker.

18. The loudspeaker of claim 17, wherein the at least two cavity structures are configured to absorb sound waves with a same frequency or different frequencies in the air-conducted sound waves.

19. The loudspeaker of claim 1, wherein the difference between the primary resonant frequency and the target frequency is within 100 Hz.

20. The loudspeaker of claim 1, wherein an amplitude difference between a peak corresponding to the primary resonant frequency and a peak corresponding to the target frequency is greater than 12 dB.
